(19) United States
(12) Patent Application Publication
(10) Pub. No.: US 2025/0206340 A1
(43) Pub. Date: Jun. 26, 2025

(54) Vehicle and Method for Controlling the Same

(71) Applicants: Hyundai Motor Company, Seoul (KR); Kia Corporation, Seoul (KR)

(72) Inventor: Yea Bin Lee, Hwaseong-Si (KR)

(21) Appl. No.: 18/962,245

(22) Filed: Nov. 27, 2024

(30) Foreign Application Priority Data
Dec. 20, 2023 (KR) 10-2023-0187315

(51) Int. Cl. B60W 60/00

(52) U.S. Cl. CPC B60W 60/001; B60W 2552/53; B60W 2556/40; B60W 2556/50

(57) ABSTRACT

An apparatus for controlling driving of a vehicle is introduced. The apparatus may comprise, a processor, a memory storing instructions, that when executed by the processor, are configured to cause the apparatus to, determine, based on GPS information and HD map information, a first position of the vehicle, determine, based on the determined first position, a first road property value, determine, based on the determined first road property value, a spatial region of the vehicle, determine, based on the determined spatial region, a second position of the vehicle, determine, based on the determined second position, a second road property value, adjust, based on the second road property value and the first road property value, a position of the vehicle in an HD map, output a signal associated with the adjusted position of the vehicle, and control, based on the signal, driving of the vehicle.

This application claims the benefit of Korean Patent Application No. 10-2023-0187315, filed in the Korean Intellectual Property Office on Dec. 20, 2023, the entire contents of which is incorporated herein by reference.

### TECHNICAL FIELD

The present disclosure relates to a vehicle and a control method thereof.

### BACKGROUND

The matters described in this Background section are only for enhancement of understanding of the background of the disclosure, and should not be taken as acknowledgment that they correspond to prior art already known to those skilled in the art.

An autonomous vehicle refers to a vehicle that perceives its driving environment, determines risks, controls its driving route, and drives itself with minimal intervention from human drivers.

This autonomous vehicle is ultimately a vehicle capable of driving, operating, and parking itself without human influence, focusing on an autonomous driving technology, a core technology on which the vehicle is based, i.e., the most advanced state of its capability that may operate the vehicle itself without active control or monitoring by a driver.

However, the concept of the autonomous vehicle may involve an intermediate step of automation toward a fully automated or autonomous vehicle, which corresponds to a goal-oriented concept predicated on the mass production and commercialization of the fully autonomous vehicle.

According to the Society of Automotive Engineers (SAE), an American organization of automotive engineers, the automation levels of autonomous vehicles are categorized from level 0 to level 5.

Unlike autonomous driving at level 4 or higher, autonomous driving at level 3 involves frequent control transfers between the human and the system during driving, which may pose more complex challenges than in fully autonomous driving.

Unlike autonomous driving at level 4 or higher where the system is responsible for the whole driving process, autonomous driving at level 3 may require a driver to be ready to drive although not requiring them to keep their eyes forward and control the vehicle in an autonomous driving mode.

Also, there may be problems due to a limited transmitting or receiving system while an autonomous vehicle travels in an autonomous driving mode of level 3 or level 4.

For example, the autonomous vehicle may experience an actual situation in which an operation scheduling of the transmitting or receiving system is slowed down or omitted as opposed to what is intended, and in the meantime, may not accurately calculate a change in the position of the vehicle.

As described above, an autonomous vehicle may fail to accurately calculate the position of the autonomous vehicle (or ego vehicle) or a change in the position and may thus use information aligned based on a road on which the ego vehicle is not located, which may trigger a risk of safety accidents by inaccurate results from precision positioning.

### SUMMARY

According to the present disclosure, an apparatus for controlling driving of a vehicle, the apparatus may comprise, a processor, a memory storing instructions, that when executed by the processor, are configured to cause the apparatus to, determine, based on global positioning system (GPS) information and High Definition (HD) map information of an HD map, a first position of the vehicle, determine, based on the determined first position of the vehicle, at least one first road property value, determine, based on the at least one first road property value, at least one first candidate spatial region of the vehicle, determine at least one second candidate spatial region by operating a position assessment operation for each of the at least one first candidate spatial region using a second position of the vehicle, the second position determined based on the GPS information and the HD map information, determine, based on the at least one second candidate spatial region, a second road property value, determine, based on the second road property value, a final position of the vehicle on the HD map, output a signal associated with the final position of the vehicle, and control, based on the signal, driving of the vehicle.

The apparatus, wherein the instructions, when executed by the processor, are further configured to cause the apparatus to, set one or more points for each of the at least one first candidate spatial region based on the corresponding first road property value, and lane lines or lanes associated with the corresponding first road property value.

The apparatus, wherein the instructions, when executed by the processor, are further configured to cause the apparatus to, determine a polygon based on the set one or more points as the corresponding first candidate spatial region of the vehicle.

The apparatus, wherein the instructions, when executed by the processor, are further configured to cause the apparatus to, determine a point of a first lane of a road link among the set one or more points, wherein the point of the first lane is a start point for generating the corresponding first candidate spatial region of the vehicle.

The apparatus, wherein the instructions, when executed by the processor, are further configured to cause the apparatus to, determine whether the vehicle is located inside or outside each of the at least one first candidate spatial region of the vehicle.

The apparatus, wherein the instructions, when executed by the processor, are further configured to cause the apparatus to, determine a position of the vehicle in relation to each of the at least one first candidate spatial region of the vehicle based on a number of points at which a semi-straight line drawn from the second position of the vehicle meets outer lines of the corresponding first candidate spatial region of the vehicle.

The apparatus, wherein the instructions, when executed by the processor, are further configured to cause the apparatus to, based on the number of points being odd, determine that the vehicle is located inside the corresponding first candidate spatial region, and based on the number of points being even, determine that the vehicle is located outside the corresponding first candidate spatial region.

The apparatus, wherein the instructions, when executed by the processor, are further configured to cause the apparatus to, select a final spatial region among the at least one second candidate spatial region based on an altitude of a previously determined spatial region and an absolute altitude of the at least one second candidate spatial region.

The apparatus, wherein the HD map information may comprise, road property information, lane property information, road geometry information, lane geometry information, road facility information, lane facility information, and map data processor (MDP) fail information.

According to the present disclosure, a method performed by an apparatus for controlling a vehicle, the method may comprise, determining, based on global positioning system (GPS) information and High Definition (HD) map information of an HD map, a first position of the vehicle, determining, based on the determined first position, at least one first road property value, determining, based on the at least one first road property value, by the controller, at least one first candidate spatial region of the vehicle, determining at least one second candidate spatial region by operating a position assessment operation for each of the at least one first candidate spatial region using a second position of the vehicle, the second position determined based on the GPS information and the HD map information, determining, based on the at least one second candidate spatial region, a second road property value, and determining, based on the second road property value, a final position of the vehicle on the HD map, and output a signal associated with the final position of the vehicle, and control, based on the signal, driving of the vehicle.

The method, wherein the determining the at least one first candidate spatial region may comprise, setting one or more points for each of the at least one first candidate spatial region based on the corresponding first road property value, and lane lines or lanes associated with the corresponding first road property value.

The method, wherein the determining the at least one first candidate spatial region may comprise, determining a polygon based on the set one or more points as the corresponding first candidate spatial region of the vehicle.

The method, wherein the determining the at least one first candidate spatial region may comprise, determining a point of a first lane of a road link among the set one or more points, wherein the point of the first lane is a start point for generating the corresponding first candidate spatial region of the vehicle.

The method, wherein the determining the at least one second candidate spatial region by operating a position assessment operation for each of the at least one first candidate spatial region using the second position of the vehicle may comprise, determining whether the vehicle is located inside or outside each of the at least one first candidate spatial region.

The method, wherein the determining whether the vehicle is located inside or outside each of the at least one first candidate spatial region may comprise, determining a position of the vehicle in relation to each of the at least one first candidate spatial region of the vehicle based on a number of points at which a semi-straight line drawn from the second position of the vehicle meets outer lines of the corresponding first candidate spatial region of the vehicle.

The method, wherein the determining whether the vehicle is located inside or outside each of the at least one first candidate spatial region may further comprise performing one of, based on the number of points being odd, determining that the vehicle is located inside the corresponding first candidate spatial region, or based on the number of points being even, determining that the vehicle is located outside the corresponding first candidate spatial region.

The method, wherein the determining of the at least one second candidate spatial region may comprise, selecting a final spatial region among the at least one second candidate spatial region based on an altitude of a previously determined spatial region and an altitude of the at least one second candidate spatial region.

The method, wherein the HD map information may comprise, road property information, lane property information, road geometry information, lane geometry information, road facility information, lane facility information, and map data processor (MDP) fail information.

A non-transitory computer-readable storage medium storing a program that, when executed, is configured to cause, determining, based on global positioning system (GPS) information and High Definition (HD) map information of an HD map, a first position of a vehicle, determining, based on the determined first position, at least one first road property value, determining, based on the at least one first road property value, at least one first candidate spatial region of the vehicle, determining a second position of the vehicle based on the GPS information and the HD map information, and determine at least one second candidate spatial region by operating a position assessment operation for each of the at least one first candidate spatial region using the second position of the vehicle, determining, based on the at least one second candidate spatial region, a second road property value, determining, based on the second road property value, a final position of the vehicle on the HD map, output a signal associated with the final position of the vehicle, and control, based on the signal, driving of the vehicle.

The non-transitory computer-readable storage medium, wherein the program, when executed, is configured to cause, setting one or more points for each of the at least one first candidate spatial region based on the corresponding first road property value, and lane lines or lanes associated with the corresponding first road property value.

### BRIEF DESCRIPTION OF THE DRAWINGS

FIG. 1A, FIG. 1B, and FIG. 1C show an example of how an autonomous vehicle estimates a current position according to the related art.

FIG. 2 shows an example of an autonomous vehicle according to an example of the present disclosure.

FIG. 3 shows an example of a method of controlling an autonomous vehicle according to an example of the present disclosure.

FIG. 4 shows an example of lanes/lines on a HD map according to an example of the present disclosure.

FIG. 5 shows an example of a polygon formed by a convex hull according to an example of the present disclosure.

FIG. 6 shows an example of a winding number according to an example of the present disclosure.

FIG. 7 shows an example of realigning a vehicle based on a road link on which the vehicle is located according to an example of the present disclosure.

### DETAILED DESCRIPTION

Hereinafter, examples of the present disclosure will be described in detail with reference to the accompanying drawings, for a better understanding of the present disclosure. The examples are not construed as limited to the disclosure and should be understood to include all changes, equivalents, and replacements within the idea and the technical scope of the disclosure. The examples of the present disclosure are provided to more fully explain the gist of the disclosure to a person having ordinary skill in the art to which the present disclosure pertains.

In the description of the examples, when an element is described as formed “above/on” or “below/under” another element, it may be construed that the two elements are in direct contact, or they are in indirect contact with one or more other elements interposed therebetween.

In this case, the use of “above/on” or “below/under” may be based on what is shown in the accompanying drawings, and these terms are used only to indicate a relative positional relationship between elements but may not be used to limit the actual positions of the elements.

In addition, relational terms such as “first” and “second,” and “above/on/upper” and “below/under/lower” may be used herein to distinguish one element or entity from another, without necessarily requiring or implying any physical or logical relationship or order between such elements or entities.

Specifically, for purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, an autonomous vehicle capable of accurately calculating a change in position of the autonomous vehicle by using HD map information aligned based on road information about a road on which the autonomous vehicle is located in real time, and a method of controlling the autonomous vehicle, will be described below with reference to the accompanying drawings.

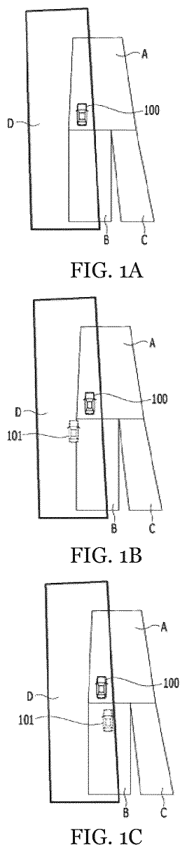

FIG. 1A, FIG. 1B, and FIG. 1C show an example of how an autonomous vehicle (also herein an “ego vehicle”) estimates a current position.

As shown in FIG. 1A, an actual current position of an ego vehicle is in area A. However, due to area D, which is an elevated road, an autonomous vehicle may estimate the position of the ego vehicle 101 as the area D which is the elevated road or as area B behind the ego vehicle 100, as shown in FIG. 1B and FIG. 1C.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of realigning or adjusting a second position of a vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of realigning or adjusting a second position of a vehicle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of realigning or adjusting a second position of a vehicle) described herein.

Minimum risk maneuver (MRM) operation(s) may also be controlled, for example, based on one or more features (e.g., features of realigning or adjusting a second position of a vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of realigning or adjusting a second position of a vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of realigning or adjusting a second position of a vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.)

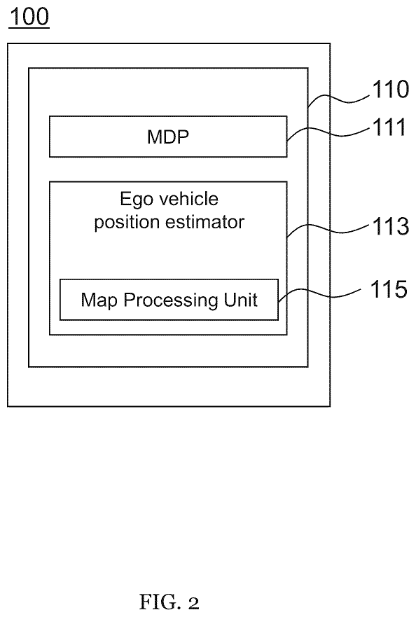

FIG. 2 shows an example of an autonomous vehicle according to an example of the present disclosure.

Referring to FIG. 2, according to an example of the present disclosure, an autonomous vehicle 100 may include a processor (e.g., circuit, circuitry, or an autonomous driving controller 110). The autonomous vehicle 100 may also be referred to herein as an ego vehicle.

The autonomous driving controller 110 may include an integrated map data processor (MDP) 111 and an ego vehicle position estimator 113. The autonomous driving controller 110 may also be referred to as an integrated autonomous driving controller.

The autonomous driving controller 110 may receive global positioning system (GPS) information provided by a connected car integrated cockpit (ccIC) controller (not shown) and HD map information of an HD map provided by a HD map server to determine whether this input data is valid. In this case, the GPS information may be received by an antenna mounted on the autonomous vehicle 100 from a plurality of artificial satellites within a transmissible/receivable distance from the autonomous vehicle 100, input to the ccIC controller, and transmitted from the ccIC controller to the autonomous driving controller 110.

The autonomous driving controller 110 may determine a first position of the autonomous vehicle 100 using the GPS information and the HD map information, and may determine at least one first road property value based on the determined first position of the autonomous vehicle 100. That is, the autonomous driving controller 110 may estimate the first position of the autonomous vehicle 100 using the GPS information and the HD map information, and may extract at least one first road link based on the estimated first position of the autonomous vehicle 100. The first road property value may be the first road link. The at least one first road property value may include a plurality of first road links which are determined to be located within a predetermined range from the first position.

The autonomous driving controller 110 may determine a first candidate position determination area of the autonomous vehicle 100 for each of the at least one first road property value, and may determine a second position of the autonomous vehicle 100 based on the GPS information and the HD map information, and determine at least one second candidate position determination area by operating a position assessment operation for each of the at least one first candidate position determination area using the second position of the vehicle. That is, the autonomous driving controller 110 may generate a polygon based on each extracted first road link. The first candidate position determination area of the autonomous vehicle 100 may be the polygon. However, examples are not limited thereto.

As described in detail below, the autonomous driving controller 110 may determine a final position determination area corresponds to a final spatial region of a vehicle used to align the vehicle's position more accurately with a map, helping to improve the reliability of location data for navigation and autonomous driving of the vehicle. The final spatial region may be a region associated with the vehicle based on the high-definition (HD) map data and the vehicle's estimated position from GPS and other positioning inputs. The final spatial region may help refine the vehicle's exact location on the map by aligning the vehicle's estimated GPS position with real-time road and lane data to mitigate errors caused by GPS inaccuracies or delays in map data processing.

The final spatial region may be used to improve the precision of the vehicle's location on the map by determining which part of the road or lane the vehicle occupies. It involves a process where nearby road attributes and properties, such as lane geometry and road edges are identified, and matched to the vehicle's position. This process may be useful in scenarios with complex road structures (e.g., overpasses, intersections), where GPS alone may not provide sufficient accuracy.

The autonomous driving controller 110 may determine a second road property value based on the selected one position determination area. The second road property value may include a second road link associated with the selected one position determination area.

The autonomous driving controller 110 may compare and analyze the second road property value and the first road property value of a first candidate position determination area in which the first position is located, and when a result value obtained by the comparison and analysis is out of a preset error range, the autonomous driving controller 110 may realign the position of the autonomous vehicle 100 based on the second road property value.

Alternatively or additionally, the autonomous driving controller 110 may compare and analyze the second road property value and the first road property value of the first candidate position determination area in which the first position is located, and when the result value obtained by the comparison and analysis is within the preset error range, the autonomous driving controller 110 may maintain the current position of the autonomous vehicle 100. In this case, when the result value is within the preset error range, the first road property value and the second road property value are substantially the same, and thus the autonomous driving controller 110 may not need to realign the current position of the autonomous vehicle 100. This will be described in more detail below.

The autonomous driving controller 110 may also estimate the position of the autonomous vehicle 100 by itself using a GPS position from the ccIC controller, and may process and transmit the HD map information about its vicinity.

The autonomous driving controller 110 may also estimate the position of the autonomous vehicle 100 using a GPS position, ccIC driving path, and precision positioning result from a high-definition map (HDM), and may process necessary information.

However, examples are not limited thereto, and any module disposed in the autonomous vehicle 100 that transmits/receives the HD map information may estimate the position of the autonomous vehicle 100 at a time each module performs computation or operations under the control of the autonomous driving controller 110.

The integrated MDP 111 may generate the HD map information including, for example, roads, lanes, facilities, and the like, in the vicinity of the autonomous vehicle 100 (or the ego vehicle) that is traveling on a road or is at rest, under the control of the autonomous driving controller 110. A HD map described herein may include various road data used for autonomous driving, such as, for example, precisely constructed lanes, traffic lights, signs, and the like.

For example, the HD map may include the road data or the HD map information including information about the height, curvature, and slope of the road, lanes, road facilities, information about various changes to the road, and the like. For example, the HD map information may include road/lane property information, road/lane geometry information, road/lane facility information, MDP fail information, and the like, which are associated with the road.

The integrated MDP 111 may detect and analyze real-time road information and the like through the autonomous vehicle 100 that is traveling on the road or is at rest, and may then receive a corresponding most recent HD map, under the control of the autonomous driving controller 110.

For example, the integrated MDP 111 may receive, in real time, a most recent HD map within a preset GPS range based on the GPS information provided by the ccIC controller, under the control of the autonomous driving controller 110. That is, the integrated MDP 111 may receive the GPS information provided by the ccIC controller and the HD map information processed based on the GPS information, under the control of the autonomous driving controller 110. The processed HD map information described above may be HD map information about an area that is separated by a preset distance based on the GPS information.

The integrated MDP 111 may receive the HD map information related to the surroundings in the GPS information based on the GPS information, which may significantly reduce a data quantity of the HD map information to facilitate real-time data transmission.

The ego vehicle position estimator 113 may receive and analyze the HD map information provided by the integrated MDP 111 and/or the GPS information provided by the ccIC controller, and the navigation map information, and estimate a precision positioning-based position based on an analysis result value obtained by the analysis, under the control of the autonomous driving controller 110.

The ego vehicle position estimator 113 may include a map processing unit 115.

The map processing unit 115 may determine the position of the autonomous vehicle 100 using the GPS information and the HD map information, determine at least one first road link based on the determined position of the autonomous vehicle 100, and may perform processing based on the at least one first road link, under the control of the autonomous driving controller 110. The at least one first road link may include one or more road links determined as located within a predetermined range from the first position of the vehicle 100. That is, the map processing unit 115 may estimate the position of the autonomous vehicle 100 using the GPS information and the HD map information, extract the one or more first road links based on the estimated position of the autonomous vehicle 100, and perform processing based on the extracted one or more first road links, under the control of the autonomous driving controller 110.

For example, the map processing unit 115 may determine a position determination area of the autonomous vehicle 100 based on each of the determined one or more first road property values, determine the second position of the autonomous vehicle 100 currently based on the GPS information and the HD map information, and determine at least one second candidate position determination area by operating a position assessment operation for each of the at least one first candidate position determination area using the second position of the vehicle, under the control of the autonomous driving controller 110. The map processing unit 115 may determine the second road property value based on the at least one second candidate position determination area, under the control of the autonomous driving controller 110. The autonomous driving controller 110 may receive the second road property value and the first road property value of the first candidate position determination area in which the first position is located from the map processing unit 115, compare and analyze them, and when an analysis result value obtained by the analysis is out of the preset error range, realign the position of the autonomous vehicle 100 based on the second road property value, thereby enabling more accurate estimation of a precision positioning-based position. This will be described in more detail below.

The autonomous driving controller 110 described above may control at least one other component (e.g., a hardware component (e.g., an interface and/or memory) and/or a software component (e.g., a software program))), and may perform various data processing and computations.

The autonomous driving controller 110 may also be referred to as a processor, a controller, a control unit, a control circuit, and the like.

The autonomous driving controller 110 may also include, although not shown, a memory. The memory may store therein various data used by the autonomous driving controller 110, the integrated MDP 111, and the ego vehicle position estimator 113, for example, input data and/or output data for software programs and commands associated therewith.

The memory may include a non-volatile memory such as cache, read-only memory (ROM), programmable ROM (PROM), erasable programmable ROM (EPROM), electrically erasable programmable ROM (EEPROM), and/or flash memory, and/or a volatile memory such as random-access memory (RAM).

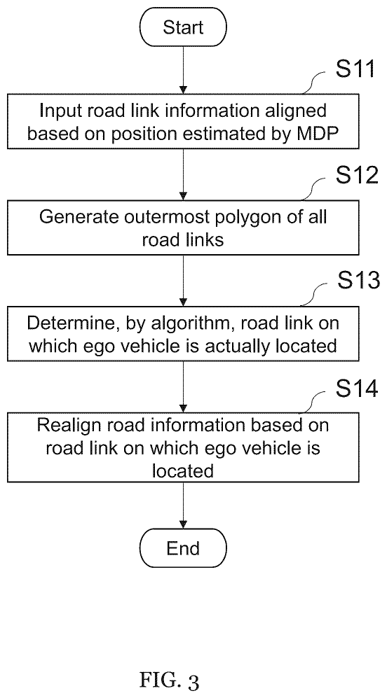

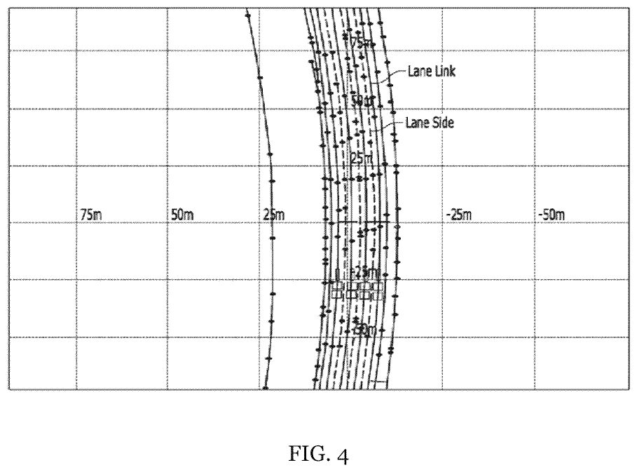

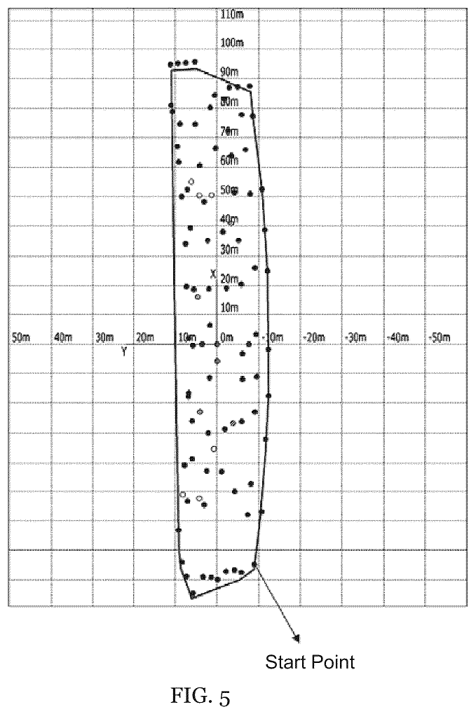

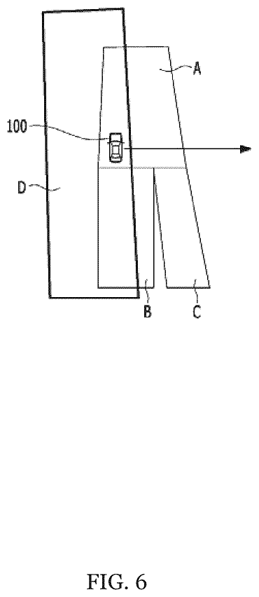

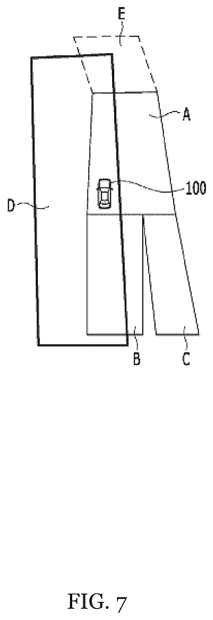

FIG. 3 shows an example of a method of controlling an autonomous vehicle according to an example of the present disclosure. FIG. 4 shows an example of lanes/lines on a HD map according to an example of the present disclosure. FIG. 5 shows an example of a polygon formed by a convex hull according to an example of the present disclosure. FIG. 6 shows an example of a winding number according to an example of the present disclosure. FIG. 7 shows an example of realigning a vehicle position based on a road link on which the vehicle is located according to an example of the present disclosure.

Referring to FIG. 3, according to an example of the present disclosure, the method of controlling the autonomous vehicle 100 is as follows. For convenience, FIG. 3 is described by way of an example in which the steps are performed by a processor (e.g., control circuitry). One, some, or all steps of FIG. 3, or portions thereof, may be performed by one or more other circuits. One or some, steps of FIG. 3 may be omitted, performed in other orders, and/or otherwise modified, and/or one or more additional steps may be added.

The autonomous vehicle 100 may determine a position of the autonomous vehicle 100 using GPS information and HD map information, and may determine at least one first road property value based on the determined position of the autonomous vehicle 100, under the control of the autonomous driving controller 110. That is, the autonomous vehicle 100 may estimate the position of the autonomous vehicle 100 using the GPS information and the HD map information, and may predict one or more first road links based on the estimated position of the autonomous vehicle 100, under the control of the autonomous driving controller 110. The one or more first road links may include one or more first road links which are located within a predetermined distant range from the first position. The first road property value may also be referred to herein as the first road link.

For example, in step S11, the autonomous vehicle 100 may input information of one or more first road links determined as located within a predetermined range on the HD map information based on the first position estimated by the integrated MDP 111, under the control of the autonomous driving controller 110.

Information of a road link, or herein road link information, may include HD map information. The road link information may include, for example, road/lane property information, road/lane geometry information, road/lane facility information, MDP fail information, and the like of the road.

The road link described herein, which is a representative example of linear representations of a road generated by connecting two road nodes, may store common properties of road segments divided by the road nodes. For example, the linearity of the road link may be stored by a non-uniform rational basis spline (NURBS) for precise curve representations. In this case, a start point of a line of the road link may be at the center of a part of a start road node or a part spot of the start road node, and an end point of the line of the road link may be at the center of a part of an end road node or a part spot of the end road node. A direction of an arrow of the road link may be independent of a driving direction.

A road link may be defined as a new road link when the number of lanes changes or when there is a merge/branch. For example, a road link k may become a road link k+1 (k is integer), which is a new road link, when the number of lanes changes or when there is a merge/branch. Herein, a unit of a road on which the autonomous vehicle 100 is located may be calculated in a unit of a road link.

For example, a mainline exit may be constructed based on the center of an off-ramp. For an even-numbered lane, start and end points may be constructed at a part spot of a road node. In contrast, for an odd-numbered lane, the start and end points may be constructed at the center of a part of the road node. However, examples are not limited thereto.

Further, a mainline entry may be constructed based on the center of an on-ramp. For an even-numbered lane, start and end points may be constructed at a part spot of a road node. In contrast, for an odd-numbered lane, the start and end points may be constructed at the center of a part of the road node.

In step S12, the autonomous vehicle 100 may then determine a first candidate position determination area of the autonomous vehicle 100 based on each of the first road links which are the determined first road property values, under the control of the autonomous driving controller 110. That is, the autonomous vehicle 100 may generate a polygon for each of the extracted first road links, under the control of the autonomous driving controller 110, in step S12.

For example, the autonomous vehicle 100 may determine the position determination area of the autonomous vehicle 100 with respect to each of the extracted first road links, under the control of the autonomous driving controller 110. The position determination area of the autonomous vehicle 100 may be a polygon or an outermost polygon. In this case, the outermost polygon may be generated for all the first road links.

As shown in FIG. 4, the autonomous vehicle 100 may set one or more points based on a determined first road link (Road Link 1), lines, or lanes, under the control of the autonomous driving controller 110. For example, the one or more points may be set based on the corresponding first road link (Road Link 1), lines, or lanes. In this case, a line described herein may be defined as a line drawn on the surface of a real road, and may also be referred to as a lane side. In this case, a lane may be defined by an imaginary center line drawn on a line and the center of the line, and may also be referred to as a lane link.

The autonomous vehicle 100 may determine the position determination area of the autonomous vehicle 100 for a first road link by using the corresponding set points, under the control of the autonomous driving controller 110. That is, the autonomous vehicle 100 may generate a polygon using the set points as the position determination area, under the control of the autonomous driving controller 110. The polygon may also be an outermost polygon.

For example, the autonomous driving controller 110 may form an outermost polygon using a predetermined algorithm, as shown in FIG. 5. The predetermined algorithm may include a Graham scan algorithm. For example, the Graham scan algorithm may be an algorithm for finding a convex hull of a finite number of points on a plane. This may have a time complexity of 0(n log n).

The Graham scan algorithm may find a border of a point for all the points on the convex hull.

In other words, the Graham scan algorithm may find the border of a point by repeating the following process for all the points. In this case, the Graham scan algorithm may repeat the process until it returns to a first point to reflect or apply it to an arrangement of the convex hull.

For example, for existing points P1 (x1, y1) and P2 (x2, y2), and a new point P3 (x3, y3), if CCW=(x2−x1) (y3−y1)−(y2−y1) (x3−x1)>0 and is counterclockwise, the autonomous driving controller 110 may add P3 to the arrangement of the convex hull, using the Graham scan algorithm.

In contrast, if CCW=(x2−x1) (y3−y1)−(y2−y1) (x3−x1)=0 and it lies on a single straight line, the autonomous driving controller 110 may remove P2 from the arrangement of the convex hull, using the Graham scan algorithm.

Further, if CCW=(x2−x1) (y3−y1)−(y2−y1) (x3−x1)<0 and is clockwise, the autonomous driving controller 110 may remove P2 from the arrangement of the convex hull, using the Graham scan algorithm.

When using the Graham scan algorithm, the autonomous driving controller 110 may select or set a start point to be a start point of a first lane, as shown in FIG. 5.

As described above, when using the Graham scan algorithm, the autonomous driving controller 110 may select or set in advance a start point of a first lane, and may accordingly generate faster an outermost polygon compared to selecting randomly the start point. Accordingly, using the Graham scan algorithm, the autonomous driving controller 110 may significantly reduce the operating time.

Subsequently, the autonomous vehicle 100 may determine a second position of the autonomous vehicle 100 based on based on the GPS information and the HD map information, under the control of the autonomous driving controller 110. Then, the autonomous vehicle 100 may determine at least one second candidate position determination area by operating a position assessment operation for each of the at least one first candidate position determination area using the second position of the vehicle.

The autonomous vehicle 100 may determine a second road property value, e.g. a second road link, with respect to the current position of the autonomous vehicle 100, under the control of the autonomous driving controller 110. That is, in step S13, the autonomous vehicle 100 may determine or select a second road link on which the autonomous vehicle 100 is actually located, under the control of the autonomous driving controller 110.

For example, in detail, the autonomous driving controller 110 may determine the at least one second candidate position determination area using the position assessment operation which is a predetermined algorithm, as shown in FIG. 6.

The predetermined algorithm may include a point-in-polygon (PIP) algorithm. For example, the PIP algorithm may be an algorithm that may determine whether the point of the second position of the autonomous vehicle 100 is located inside or outside a polygon including a finite number of points on a plane.

The autonomous driving controller 110 may calculate a winding number, which is the number of points where a semi-straight line drawn in all directions from the autonomous vehicle 100 meets the outlines of the polygon. Preferably, the autonomous driving controller 110 may calculate the winding number, which is the number of points where a semi-straight line drawn in a lateral direction from the autonomous vehicle 100 meets the outlines of the polygon, to determine a position of the autonomous vehicle 100 or a road link on which the autonomous vehicle 100 is actually located.

For example, in response to the winding number being an odd number for a polygon, which is a position determination area of the autonomous vehicle 100, the autonomous driving controller 110 may determine that the position of the autonomous vehicle 100 is inside the polygon, i.e. inside the position determination area. In response to the winding number being an even number, the autonomous driving controller 110 may determine that the position of the autonomous vehicle 100 is outside the polygon.

In FIG. 6, polygons, which are position determination areas of the autonomous vehicle 100, are represented respectively as areas A, B, C, and D to provide an easier explanation of the present disclosure.

As shown in FIG. 6, the autonomous driving controller 110 may calculate a winding number, which is the number of windings where a semi-straight line drawn in a lateral direction from the autonomous vehicle 100, i.e. from the second position meets outlines of each of the polygonal areas A, B, C, and D. The calculated winding numbers may be as follows.

The winding number of area A is 1, the winding number of area B is 0, the winding number of area C is 0, and the winding number of area D is 1.

Based on the calculated winding numbers, the autonomous driving controller 110 may determine that the autonomous vehicle 100 is located inside the areas A and D, and outside the areas B and C. Based on the calculated winding numbers, the autonomous driving controller 110 may determine that the autonomous vehicle 100 is located on the road link associated with the area A and also on the road link associated with the area D.

The road link of the area A may be referred to as road link A, the road link of the area B may be referred to as road link B, the road link of the area C may be referred to as road link C, and the road link of the area D may be referred to as road link D.

Further, the autonomous driving controller 110 may calculate an altitude of the autonomous vehicle 100 by comparing an absolute altitude (in meters (m) above sea level) of a road link calculated in a previous time period to an absolute altitude of a road link (e.g., A and D) on which the autonomous vehicle 100 is currently located. For example, the autonomous driving controller 110 may select or determine, as a final road link of the autonomous vehicle 100, a road link with a smaller difference in absolute altitude as a result of the comparison.

Subsequently, the autonomous vehicle 100 may realign the road link based on the calculated position of the autonomous vehicle 100, under the control of the autonomous driving controller 110. That is, in step S14, the autonomous vehicle 100 may realign road information based on the road link on which the autonomous vehicle 100 is located, under the control of the autonomous driving controller 110.

For example, under the control of the autonomous driving controller 110, the autonomous vehicle 100 may compare and analyze the second road property value and the first road property value associated with the first position determination area where the autonomous vehicle 100 is located and, when an analysis result value obtained by the analysis is out of a preset error range, may realign the position of the autonomous vehicle 100 based on the second road property value.

Alternatively or additionally, under the control of the autonomous driving controller 110, the autonomous vehicle 100 may compare and analyze the second road property value and the first road property value and, when the analysis result value is within the preset error range, may maintain the current position of the autonomous vehicle 100. In this case, the current position of the autonomous vehicle 100 may not need to be realigned because the first road property value and the second road property value are substantially the same when the analysis result value is within the preset error range.

For example, the autonomous vehicle 100 may realign all the calculated road links based on the position of the autonomous vehicle 100, under the control of the autonomous driving controller 110. The autonomous vehicle 100 may extract connectivity information for each of all the calculated road links based on the position of the autonomous vehicle 100 and realign the road links based on the extracted connectivity information, under the control of the autonomous driving controller 110.

For example, as shown in FIG. 7, when the autonomous vehicle 100 is determined to be located on road link A, the autonomous vehicle 100 may realign all road links by assigning attributes (or properties), for example, assigning road link E to the front side of the autonomous vehicle 100, road link B to the rear left side of the autonomous vehicle 100, road link C to the rear right side of the autonomous vehicle 100, and road link D on which the autonomous vehicle is not present as “extra,” under the control of the autonomous driving controller 110.

As described above, the autonomous vehicle 100 may realign road links based on a calculated position of the autonomous vehicle 100 under the control of the autonomous driving controller 110, thereby removing the adverse effects of a time error and improving reliability of autonomous driving.

As described above, the autonomous vehicle 100 may realign road links based on a calculated position of the autonomous vehicle 100 under the control of the autonomous driving controller 110, thereby easily obtaining a HD map in real time and ensuring reliability of a precision positioning system even in a case where an elevated road overlaps, a structure of road links is complex, or a time error occurs due to limitations of a transmission/reception system.

Meanwhile, a non-transitory computer-readable recording medium recording therein a program for executing the method of controlling the autonomous vehicle 100 according to an example of the present disclosure may record the program implementing the related functions, and a computer may read the recording medium.

The autonomous driving controller 110 may be a processor (e.g., a central processing unit (CPU)) or a semiconductor device that processes instructions stored in a memory and/or a storage. The memory and the storage may include various types of volatile or non-volatile storage media. For example, the memory may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor. The software module may reside on a storage medium (that is, the memory and/or the storage) such as a RAM, a flash memory, a ROM, an EPROM, an EEPROM, a register, a hard disc, a removable disk, and a CD-ROM.

The exemplary storage medium may be coupled to the processor. The processor may read out information from the storage medium and may write information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

An object of the present disclosure is to provide an autonomous vehicle and a control method thereof that may accurately calculate a change in position of the autonomous vehicle using HD map information aligned based on road information about a road on which the autonomous vehicle is located in real time.

According to an example of the present disclosure, there is provided a vehicle including a driving controller. The driving controller may be configured to determine a first position of the vehicle using global positioning system (GPS) information and HD (High Definition) map information, determine at least one first road property value based on the determined first position of the vehicle, determine at least one first position determination area of the vehicle based on the at least one first road property values, determine a second position of the vehicle based on the GPS information and the HD map information and determine at least one second candidate position determination area by operating a position assessment operation for each of the at least one first candidate spatial region using the second position of the vehicle, determine a second road property value based on the at least one second candidate position determination area, and realign the position of the vehicle based on the second road property value and the first road property value of the first candidate position determination area where the autonomous vehicle 100 was located.

The driving controller may be configured to set one or more points for each of the at least one first candidate spatial region based on the corresponding first road property value, and lane lines or lanes associated with the corresponding first road property value.

The autonomous driving controller may be configured to determine a polygon based on the set one or more points as the corresponding first candidate spatial region of the vehicle.

The autonomous driving controller may be configured to determine a point of a first lane of a road link among the set one or more points as a start point for generating the corresponding first candidate position determination area.

The autonomous driving controller may be configured to determine whether the vehicle is located inside or outside each of the at least one first candidate position determination area.

The autonomous driving controller may be configured to determine a position of the vehicle in relation to each of the at least one first candidate spatial region of the vehicle based on a number of points at which a semi-straight line drawn from the second position of the vehicle meets outer lines of the corresponding first candidate position determination area of the vehicle.

The autonomous driving controller may be configured to, in response to the number of points being odd, determine that the vehicle is located inside the corresponding first candidate position determination area, and in response to the number of points being even, determine that the vehicle is located outside the corresponding first candidate position determination area.

The autonomous driving controller may be configured to select a final position determination area among the at least one second candidate position determination area based on an altitude of a previously determined position determination area and an absolute altitude of the at least one second candidate position determination area.

The HD map information may include road/lane property information, road/lane geometry information, road/lane facility information, and map data processor (MDP) fail information.

According to an example of the present disclosure, there is provided a method of controlling a vehicle including a driving controller, the method including determining, by a controller, a first position of the vehicle using global positioning system (GPS) information and HD (High Definition) map information of an HD map, determining, by the controller, at least one first road property value based on the at least one first position, determining, by the controller, at least one first candidate position determination area of the vehicle based on the at least one first road property value, determining, by the controller, at least one second candidate position determination area by operating a position assessment operation for each of the at least one first candidate position determination area using a second position of the vehicle, the second position determined based on the GPS information and the HD map information, determining, by the controller, a second road property value based on the at least one second candidate position determination area, and realigning, by the controller, the position of the vehicle based on the second road property value and the first road property value associated with the first candidate position determination area where the autonomous vehicle 100 was located.

The determining of a position determination area may include setting one or more points for each of the at least one first candidate position determination area based on the corresponding first road property value, lane lines, or lanes associated with the corresponding first road property value.

The determining of a position determination area may comprise determining a polygon as the corresponding first candidate position determination area using the set one or more points.

The determining of a position determination area may comprise determining a point of a first lane of a road link as a start point for generating the corresponding first candidate position determination area.

The determining of the at least one second candidate position determination by operating a position assessment operation for each of the at least one first candidate position determination using the second position of the vehicle may comprise determining whether the vehicle is located inside or outside each of the at least one first candidate position determination area.

The determining of whether the vehicle is located inside or outside each of the at least one first candidate position determination area may comprise determining a position of the vehicle in relation to each of the at least one first candidate position determination of the vehicle based on a number of points at which a semi-straight line drawn from the second position of the vehicle meets outer lines of the corresponding first candidate position determination area.

The determining of whether the vehicle is located inside or outside each of the at least one first candidate position determination area may further comprise in response to the number of points being odd, determining that the vehicle is located inside the corresponding first candidate position determination area, and in response to the number of points being even, determining that the vehicle is located outside the corresponding first candidate position determination area.

The determining of the at least one second candidate position determination may further comprise selecting a final position determination among the at least one second candidate position determination based on an altitude of a previously determined position determination area and an altitude of the at least one second candidate position determination area.

The HD map information may include road/lane property information, road/lane geometry information, road/lane facility information, and MDP fail information.

According to an example of the present disclosure, there is provided a non-transitory computer-readable storage medium storing a program for executing the method described above.

The autonomous vehicle and the control method configured as described above according to examples of the present disclosure may improve the reliability of autonomous driving by calculating a road link based on a position of the autonomous vehicle, realigning the calculated road link, and removing an adverse effect from a time error.

The autonomous vehicle and the control method configured as described above according to examples of the present disclosure may calculate a road link based on a position of the autonomous vehicle and realign the calculated road link to facilitate real-time performance of a HD map even in the case of an overlapping elevated road, a complex structure of road links, and a time error from the limitations of a transmitting/receiving system, thereby ensuring the stability of a precision positioning system.

The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like. In addition, computer-readable recording media may be distributed across networked computer systems, such that computer-readable code may be stored and executed in a distributed manner. Also, functional programs, code, and code segments for implementing the method may be readily inferred by programmers of ordinary skill in the art to which the present disclosure pertains.

The various examples described herein may be combined with each other without departing from the objectives of the present disclosure, provided they are not inconsistent with each other. Furthermore, if a component of any of the various examples described herein is not described in detail, the description of a component having the same reference numeral in another example may be incorporated therefrom.

Accordingly, the preceding detailed description should not be construed as restrictive but as illustrative in all respects. The scope of the examples of the present disclosure should be determined by reasonable interpretation of the appended claims, and all changes and modifications within the equivalent scope of the present disclosure are included in the scope of the present disclosure.

What is claimed is:

1. An apparatus for controlling driving of a vehicle, the apparatus comprises:
a processor;
a memory storing instructions, that when executed by the processor, are configured to cause the apparatus to:
determine, based on global positioning system (GPS) information and High Definition (HD) map information of an HD map, a first position of the vehicle;
determine, based on the determined first position of the vehicle, at least one first road property value;
determine, based on the at least one first road property value, at least one first candidate spatial region of the vehicle;
determine at least one second candidate spatial region by operating a position assessment operation for each of the at least one first candidate spatial region using a second position of the vehicle, the second position determined based on the GPS information and the HD map information;
determine, based on the at least one second candidate spatial region, a second road property value;
determine, based on the second road property value, a final position of the vehicle on the HD map;
output a signal associated with the final position of the vehicle; and
control, based on the signal, driving of the vehicle.

2. The apparatus of claim 1, wherein the instructions, when executed by the processor, are further configured to cause the apparatus to:
set one or more points for each of the at least one first candidate spatial region based on the corresponding first road property value, and lane lines or lanes associated with the corresponding first road property value.

3. The apparatus of claim 2, wherein the instructions, when executed by the processor, are further configured to cause the apparatus to:
determine a polygon based on the set one or more points as the corresponding first candidate spatial region of the vehicle.

4. The apparatus of claim 3, wherein the instructions, when executed by the processor, are further configured to cause the apparatus to:
determine a point of a first lane of a road link among the set one or more points, wherein the point of the first lane is a start point for generating the corresponding first candidate spatial region of the vehicle.

5. The apparatus of claim 2, wherein the instructions, when executed by the processor, are further configured to cause the apparatus to:
determine whether the vehicle is located inside or outside each of the at least one first candidate spatial region of the vehicle.

6. The apparatus of claim 5, wherein the instructions, when executed by the processor, are further configured to cause the apparatus to:
determine a position of the vehicle in relation to each of the at least one first candidate spatial region of the vehicle based on a number of points at which a semi-straight line drawn from the second position of the vehicle meets outer lines of the corresponding first candidate spatial region of the vehicle.

7. The apparatus of claim 6, wherein the instructions, when executed by the processor, are further configured to cause the apparatus to:
based on the number of points being odd, determine that the vehicle is located inside the corresponding first candidate spatial region; and
based on the number of points being even, determine that the vehicle is located outside the corresponding first candidate spatial region.

8. The apparatus of claim 7, wherein the instructions, when executed by the processor, are further configured to cause the apparatus to:
select a final spatial region among the at least one second candidate spatial region based on an altitude of a previously determined spatial region and an absolute altitude of the at least one second candidate spatial region.

9. The apparatus of claim 1, wherein the HD map information comprises:
road property information,
lane property information,
road geometry information,
lane geometry information,
road facility information,
lane facility information, and
map data processor (MDP) fail information.

10. A method performed by an apparatus for controlling a vehicle, the method comprising:
determining, based on global positioning system (GPS) information and High Definition (HD) map information of an HD map, a first position of the vehicle;
determining, based on the determined first position, at least one first road property value;
determining, based on the at least one first road property value, by the controller, at least one first candidate spatial region of the vehicle;
determining at least one second candidate spatial region by operating a position assessment operation for each of the at least one first candidate spatial region using a second position of the vehicle, the second position determined based on the GPS information and the HD map information;
determining, based on the at least one second candidate spatial region, a second road property value; and
determining, based on the second road property value, a final position of the vehicle on the HD map; and
output a signal associated with the final position of the vehicle; and
control, based on the signal, driving of the vehicle.

11. The method of claim 10, wherein the determining the at least one first candidate spatial region comprises:
setting one or more points for each of the at least one first candidate spatial region based on the corresponding first road property value, and lane lines or lanes associated with the corresponding first road property value.

12. The method of claim 11, wherein the determining the at least one first candidate spatial region comprises:
determining a polygon based on the set one or more points as the corresponding first candidate spatial region of the vehicle.

13. The method of claim 12, wherein the determining the at least one first candidate spatial region comprises:
determining a point of a first lane of a road link among the set one or more points, wherein the point of the first lane is a start point for generating the corresponding first candidate spatial region of the vehicle.

14. The method of claim 13, wherein the determining the at least one second candidate spatial region by operating a position assessment operation for each of the at least one first candidate spatial region using the second position of the vehicle comprises:
determining whether the vehicle is located inside or outside each of the at least one first candidate spatial region.

15. The method of claim 14, wherein the determining whether the vehicle is located inside or outside each of the at least one first candidate spatial region comprises:
determining a position of the vehicle in relation to each of the at least one first candidate spatial region of the vehicle based on a number of points at which a semi-straight line drawn from the second position of the vehicle meets outer lines of the corresponding first candidate spatial region of the vehicle.

16. The method of claim 15, wherein the determining whether the vehicle is located inside or outside each of the at least one first candidate spatial region further comprises performing one of:
based on the number of points being odd, determining that the vehicle is located inside the corresponding first candidate spatial region; or
based on the number of points being even, determining that the vehicle is located outside the corresponding first candidate spatial region.

17. The method of claim 16, wherein the determining of the at least one second candidate spatial region comprises:
selecting a final spatial region among the at least one second candidate spatial region based on an altitude of a previously determined spatial region and an altitude of the at least one second candidate spatial region.

18. The method of claim 10, wherein the HD map information comprises:
road property information,
lane property information,
road geometry information,
lane geometry information,
road facility information,
lane facility information, and
map data processor (MDP) fail information.

19. A non-transitory computer-readable storage medium storing a program that, when executed, is configured to cause:
determining, based on global positioning system (GPS) information and High Definition (HD) map information of an HD map, a first position of a vehicle;
determining, based on the determined first position, at least one first road property value;
determining, based on the at least one first road property value, at least one first candidate spatial region of the vehicle;
determining a second position of the vehicle based on the GPS information and the HD map information, and determine at least one second candidate spatial region by operating a position assessment operation for each of the at least one first candidate spatial region using the second position of the vehicle;
determining, based on the at least one second candidate spatial region, a second road property value;
determining, based on the second road property value, a final position of the vehicle on the HD map;
output a signal associated with the final position of the vehicle; and
control, based on the signal, driving of the vehicle.

20. The non-transitory computer-readable storage medium of claim 19, wherein the program, when executed, is configured to cause:
setting one or more points for each of the at least one first candidate spatial region based on the corresponding first road property value, and lane lines or lanes associated with the corresponding first road property value.
